(19) United States
(12) Patent Application Publication
(10) Pub. No.: US 2026/0074170 A1
(43) Pub. Date: Mar. 12, 2026

(54) METHODS AND SYSTEMS FOR INDIVIDUAL ION MASS SPECTROMETRY

(71) Applicant: Northwestern University, Evanston, IL (US)

(72) Inventors: John P. McGee, Evanston, IL (US); Bryon Shane Drown, Evanston, IL (US); Jared Otto Kafader, Evanston, IL (US); Neil L. Kelleher, Evanston, IL (US); Philip D. Compton, Evanston, IL (US)

(21) Appl. No.: 18/871,150

(22) PCT Filed: Jun. 2, 2023
(86) PCT No.: PCT/US2023/067861

§ 371 Date: Dec. 2, 2024

Related U.S. Application Data
(60) Provisional application No. 63/348,366, filed on Jun. 2, 2022.

(51) Int. Cl. H01J 49/00

(52) U.S. Cl. CPC H01J 49/0036; H01J 49/0031; H01J 49/004

(57) ABSTRACT

Disclosed herein are methods and systems for individual ion mass spectrometry (I²MS). The methods and systems described herein parse I²MS data and allows for informed tandem mass spectrometry analyses by determining a target m/z that increases the yield of an intact mass corresponding to an analyte of interest while reducing the yield of additional detectable masses.

### CROSS-REFERENCE TO RELATED APPLICATIONS

This application claims benefit of priority to U.S. patent application Ser. No. 63/348,366, filed Jun. 2, 2022, the contents to which is incorporated herein by reference in its entirety.

### REFERENCE TO AN ELECTRONIC SEQUENCE LISTING

A Sequence Listing accompanies this application and is submitted as an ASCII text file of the sequence listing named “70258102351.xml” which is 8,257 bytes in size and was created on Dec. 2, 2024. The sequence listing is electronically submitted via EFS-Web with the application and is incorporated herein by reference in its entirety.

### BACKGROUND OF THE INVENTION

Individual Ion Mass Spectrometry (I²MS) can resolve an entire proteome simultaneously and directly into the mass domain. However, prior usage of I²MS has not considered where a specific proteoform can be isolated in an m/z-space spectrum for characterization, especially if the protein mixture is densely heterogeneous. Characterizing proteoforms through isolation and fragmentation is a fundamental part of top-down mass spectrometry and proteoform annotation. As a result, there is a need for methods and systems for parsing I²MS data and I²MS-informed tandem mass spectrometry analyses.

### BRIEF SUMMARY OF THE INVENTION

Disclosed herein are methods and systems for individual ion mass spectrometry (I²MS). The methods and systems described herein parse I²MS data and allows for informed tandem mass spectrometry analyses by determining a target m/z that increases the yield of an intact-mass corresponding to an analyte of interest while reducing the yield of additional detectable masses. The framework allows for tandem I²MS analyses to be conducted automatically in sequence, not only within a single sample but also across entire sample series.

On aspect of the technology is a method for determining a target m/z. The method comprises producing, with an ion source, ions of a sample, each of the ions having a mass-to-charge ratio (m/z); generating, with a detector, detector signals corresponding to the m/z ratios of ions in the sample; and determining, with a controller, the target m/z, wherein the target m/z is selected for an intact-mass corresponding to an analyte of interest. In some embodiments, the target m/z is determined using I²MS survey data, which can be obtained from time domain or intensity based metric.

Another aspect of the technology is a method for determining a mass spectrum. The method comprises producing, with an ion source, ions of a sample, each of the ions having a mass-to-charge (m/z) ratio; generating, with a detector, detector signals at a target m/z, wherein the target m/z is selected for an intact-mass corresponding to an analyte of interest; and determining, with a mass analyzer, a mass spectrum for the target m/z.

Another aspect of the technology is a method for generating a target mass report. The method comprises producing, with an ion source, ions of a sample, each of the ions having a mass-to-charge (m/z) ratio; generating, with a detector, detector signals corresponding to the m/z ratios of ions in the sample; and generating, with a controller, a target mass report, wherein the target mass report comprises a target mass for an analyte of interest, one or more target m/z for the target mass of the analyte of interest, a charge state for each of the one of more target m/z, and, if present, additional detectable masses for each target m/z.

Another aspect of the technology is a system for determining a target m/z. The system comprises (a) an inlet portion configured to receive a sample; (b) an ion source configured to ionize the sample to ions, each of the ions having a mass-to-charge (m/z) ratio; (c) the detector configured to generate detector signals corresponding to the m/z ratio of detected ions; and (e) a controller configured to receive the detector signals and programmed to determine the target m/z, wherein the target m/z is selected for an intact-mass corresponding to an analyte of interest.

Another aspect of the technology is a system for determining a mass spectrum. The system comprises (a) an inlet portion configured to receive a sample; (b) an ion source configured to ionize the sample to ions, each of the ions having a mass-to-charge (m/z) ratio; (c) an ion selector configured to select ions having a target m/z; (d) the detector configured to generate detector signals corresponding to the selected ions; and; (e) a controller configured to receive the detector signals and programmed to determine a mass spectrum, wherein the target m/z is selected for an intact-mass corresponding to an analyte of interest.

Another aspect of the technology is a system for generating a target mass report. The system comprising (a) an inlet portion configured to receive a sample; (b) an ion source configured to ionize the sample to ions, each of the ions having a mass-to-charge (m/z) ratio; (c) the detector configured to generate detector signals corresponding to the m/z ratio of detected ions; and (e) a controller configured to receive the detector signals and programmed to generate a target mass report, wherein the target mass report comprises a target mass for an analyte of interest, one or more target m/z for the target mass of the analyte of interest, a charge state for each of the one of more target m/z, and, if present, additional detectable masses for each target m/z.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 provides a block diagram of the workflow for determining a list of ideal targets in m/z space for the characterization of species on a theoretical future targeted data acquisition series using intact mass spectra.

FIG. 2. An illustration of the I²MS process.

FIG. 3. A block diagram of a controller.

FIG. 4. Exemplary workflow on a protein mixture (Pierce protein mix) including an m/z spectrum of the protein mixture (a), mass spectrum created using charge detection mass spectrometry such as I²MS using an Orbitrap mass analyzer (b). recreation of m/z spectra of protein components (c), and subsequent activation of determined minimal overlapping charge states (d).

FIG. 5. Identified fragments from selected proteoforms of human IGF-1 LR3 (SEQ ID NO: 1) within the Pierce Protein Standard Mix.

FIG. 6. Identified fragments from selected proteoforms of Streptococcus protein A/G (SEQ ID NO: 2) within the Pierce Protein Standard Mix.

FIG. 7. Identified fragments from selected proteoforms of bovine carbonic anhydrase II (SEQ ID NO: 3) within the Pierce Protein Standard Mix.

FIG. 8. Identified fragments from selected proteoforms of S. dysgalactiae protein G (SEQ ID NO: 4) within the Pierce Protein Standard Mix.

FIG. 9. Identified fragments from selected proteoforms of E. coli exo klenow (SEQ ID NO: 5) within the Pierce Protein Standard Mix.

FIG. 10. Utilization of the methods and systems described herein for direct data-dependent analysis on a complex, non-standard mixture of proteins including this example of proteins being liberated directly from a kidney tissue sample.

FIG. 11. (a) Sum of survey I²MS spectra performed on the line area on a human ovary tumor tissue (shown in panel b). The name of the proteoforms identified are annotated in the spectrum. The region highlighted and magnified contains diverse modified proteoforms of HSPB1 and two GSTP1 proteoforms from a biallelic expression. (b) Illustration of PiMS2 data acquisition (top). Optical image at top right shows the size of the liquid bridge (˜80 μm) formed between the probe and the tissue. The regions where survey and MS/MS experiments were performed are highlighted using the grids on top of the tissue image (a H & E stained adjacent section). The heatmap at bottom shows the relative abundances of the proteoform targets across space (aligned with the grids on tissue). The spatial abundance in each row corresponds to a singular charge state of a proteoform detected in the survey scans, and are normalized to the most abundant abundance in the heatmap. The proteoform masses and IDs are labeled on the left and right of the heatmap, respectively. The two masses in grey are not identified. (c) A plot of molecular masses and relative abundances of the proteoforms summed from the survey scans. The color indicates the −log (E-value) of the fragment matching results. (d) Graphical fragment map of alpha-enolase (SEQ ID NO: 6). The flags in the map respectively represent the fragments found in the MS/MS data processed via individual ion mass spectrometry workflow, ensemble averaging, and common fragments found in both modes mentioned above. Abbreviations used: peptidylprolyl isomerase A (PPIA); Parkinson disease protein 7 (PARK7); NADH dehydrogenase [ubiquinone] 1 beta subcomplex subunit 10 (NBUDA); phosphatidylethanolamine-binding protein 1 (PEBP1); transgelin-2 (TAGL2); heat shock protein beta-1 (HSPB1); glutathione S-transferase P (GSTP1); peroxiredoxin-6 (PRDX6); galectin-3 (LEG3); triosephosphate isomerase (TPIS); 14-3-3 protein zeta/delta (1433Z); apolipoprotein A-I (APOA1); malate dehydrogenase, mitochondrial (MDHM); glyceraldehyde-3-phosphate dehydrogenase (GAPDH); porphobilinogen deaminase (HEM3); actin, cytoplasmic 2 (ACTG); phosphoglycerate kinase 1 (PGK1); and alpha-enolase (ENOA).

### DETAILED DESCRIPTION OF THE INVENTION

Disclosed herein are methods and systems for individual ion mass spectrometry (I²MS). I²MS, also known as Charge Detection Mass Spectrometry (CDMS), requires that each detected signal within an individual spectrum be resolved from every other signal in that spectrum along the mass-to-charge (m/z) domain. If signals overlap in the m/z domain, it becomes difficult to determine whether there are multiple individual ions contributing to the signal or one ion of the summed charge of the individual ions. The methods and systems described herein parse I²MS data and allows for informed tandem mass spectrometry analyses by determining a target m/z that increases the yield of an intact-mass corresponding to an analyte of interest while reducing the yield of additional detectable masses. Importantly, the technology performs regardless of whether or not individual species can be resolved in an original, unprocessed data set. While the application described herein resembles a “data-dependent” acquisition scheme for the purpose of clarity, the methods and systems are adaptable to data-independent schema as well. Overall, the framework allows for tandem I²MS analyses to be conducted automatically in sequence, not only within a single sample but also across entire sample series.

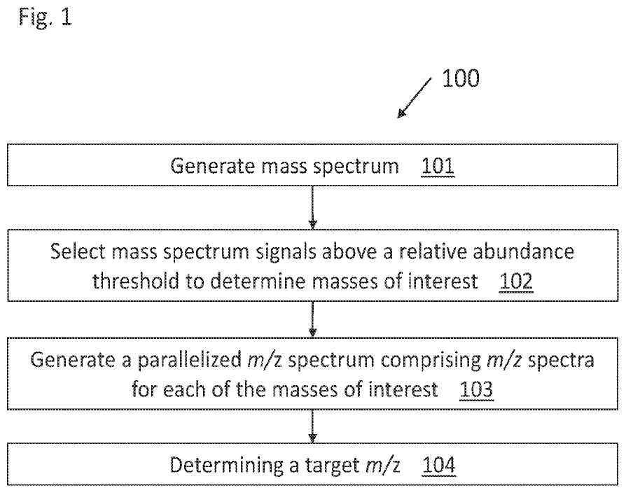

FIG. 1 illustrates a method for determining a target m/z 100. “Target m/z” refers to a window within m/z space where an analyte of interest having an intact mass is expected. “Intact mass” refers to the mass of the analyte of interest without fragmentation. The determined target m/z is selected to isolate the yield of the intact-mass corresponding to the analyte of interest from one or more additional detectable masses. The one or more additional detectable masses may comprise a mass of a fragment of the analyte of interest or a mass of an off-target species or fragment thereof. In some embodiments, the yield of the analyte of interest results in the majority of the single ions at a target m/z to be attributed to the analyte of interest, e.g., at least 50%, 60%, 70%, 80%, 90%, 95%, 98%, or 99%. The window for the target m/z may be chosen to have low enough resolution so as not to classify multiple isotopologues belonging to the same analyte of interest as separate targets. The width of the m/z target window may be user-altered to account for broader species signal distributions, narrower species signal distributions, minimization of co-isolates, anticipated variability in quadrupole isolation precision, or any other consideration that may lead a user to want to alter the width of the m/z target.

A sample may be ionized by an ion source to produce ions having a m/z ratio, and the ions may be detected by a detector to generate detector signals corresponding to the m/z rations of ions in the same. To determine the target m/z, a mass spectrum is generated 101. Mass spectrometry uses ions to measure the m/z ratio of molecules once lifted into the gas phase. Denatured and native electrospray ionization of intact proteins and their complexes pose many complications due to sample heterogeneity and large charge-state envelopes in the m/z domain. To simplify analysis, charge detection mass spectrometry (CDMS) has enabled the generation of true mass spectra with the direct readout of an ion's integer charge value. I²MS allows for measuring complex proteoform mixtures and their complexes without the need to separate the proteoforms prior to identification. [Kafader, J. O. Nat Methods 17, 391-394 (2020)]

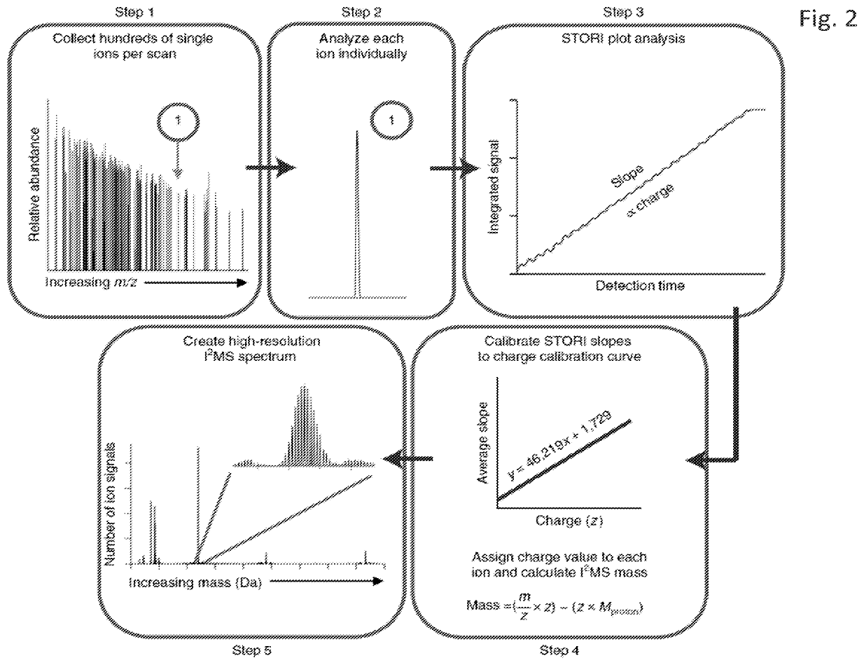

FIG. 2 illustrates the I²MS approach. In step 1 (FIG. 2) of the I²MS approach, ions may be observed per acquisition in a random-style trapping event. Parallelizing ion observation can decrease the data acquisition burden by ˜100-fold over current CDMS techniques. Owing to the sensitivity of I²MS, protein solutions can be diluted down by orders of magnitude (into the high pM to low nM range). In step 2 (FIG. 2), the frequency of each ion signal is determined and analyzed independently. At this processing stage, precise information for each ion, including frequency, intensity and m/z value, is established. Step 3 (FIG. 2) determines the ion's signal strength using a data-plotting and data-analysis process that assesses the current induced by an ion on the detection electrodes as a function of acquisition time. For simplicity, this signal strength determination may be called the selective temporal overview of resonant ions (STORI) process, with the slope of a STORI plot being proportional to the charge of the ion (step 3, FIG. 2). In step 4, the charge of the ion is determined by a slope-to-charge calibration function. The STORI slope of an ion with an unknown charge is assigned the closest integer charge state on the calibration function. Each calibration function was created just once for each of the two Q-Exactive style instruments used in this study. Using the integer charge (z) and m/z, it is possible to determine the mass of each ion and produce a spectrum in the true mass domain with different spectral properties and increased resolution via centroiding and binning individual ion signals.

Referring again the FIG. 1, masses of interest are determined by selecting mass spectrum signals above a relative intensity threshold 102. By using charge-assigned ion data in the mass domain, all prominent species in a complex mixture may be assigned as a mass of interest. The masses of interest may be determined by a mass signal having a relative intensity above a user defined threshold or by using peak-picking algorithms above a relative intensity threshold.

In some embodiments, a table of detected ions can be extracted from an I²MS file using database manipulation software such as SQLite. Masses may be flagged for characterization without prior knowledge of the nature or identity of the constituent targets, and masses do not need to constitute one and only one species for effective characterization. The ion table may include one or more entries where a charge could not be assigned to an ion. The script uses the ion table to construct the product mass spectrum, giving the script full control over the product spectrum from the original I²MS workflow. Then, the script detects every mass peak above the relative intensity threshold, using a low enough resolution as to not classify multiple isotopologues belonging to the same proteoform as separate targets. The script may smooth the spectrum further, which may employ any from a number of algorithms such as Savitzy-Golay filtering, to reduce the presence of unwanted anomalies such as spectral artifacts. The script may employ any from a number of peak-picking algorithms with the intent to identify individual, non-erroneous features resolved in the mass domain by I²MS

In some implementations, the sample will have a multiplicity of masses of interest corresponding to two or more analytes of interest. Each of the masses of interest for one or more analytes of interest may be included in target mass report.

Once a mass of interest has been identified, a parallelized m/z spectrum is generated 103. This allows for each species to be viewed in isolation in silico. Each mass peak's constituent ions are used to recreate m/z spectra as if the sample consisted of purely the identified mass of interest. This is repeated for every identified mass of interest to create a series of isolated m/z spectra.

The target m/z is determined from the parallelized m/z spectrum 104. Comparison of the peaks of each m/z spectrum relative to those of other spectra are used determine the ideal places in m/z space to target for the characterization of an analyte of interest on a future targeted data acquisition series. In some embodiments, the controller is programmed pick a place in m/z space that maximizes the response of the current target while minimizing the response of additionally detectable masses. Comparisons may be made between the ion count of the target versus the summed ion count of the co-isolates. Absolute ion count of the target may also be considered over elimination of all co-isolates.

For any sample, a multiplicity of target m/z may be determined where two or more target m/z are associated with a single analyte of interest, different analytes of interest, or a combination thereof. The mass target report may include, in addition to the masses of interest, one or more target m/z for any analyte of interest, and a charge state for each of the target m/z. The mass report may be used with automated acquisition programs, such as Autopilot, to enhance the capacity for I²MS analyses. Fragmentation data may be acquired in any of a multitude of modes, including single ion (I²MS) or traditional (ensemble) modes. Furthermore, the utilized fragmentation method is flexible and independent of the methods and systems described herein. Some examples include collisions with background gas, collisions against a solid surface, gas phase chemical reactions, and electromagnetic or photon bombardment.

The mass target report may also include information on additional detectable masses for each target m/z, including target ion count, co-isolating species and co-isolate ion count. Such information may be used with future data-independent implementations. For example, multiple larger isolation windows can be targeted, and the combinations and ratios of co-isolates in each window can be used to annotate fragments that appear in corresponding combinations and ratios across windows.

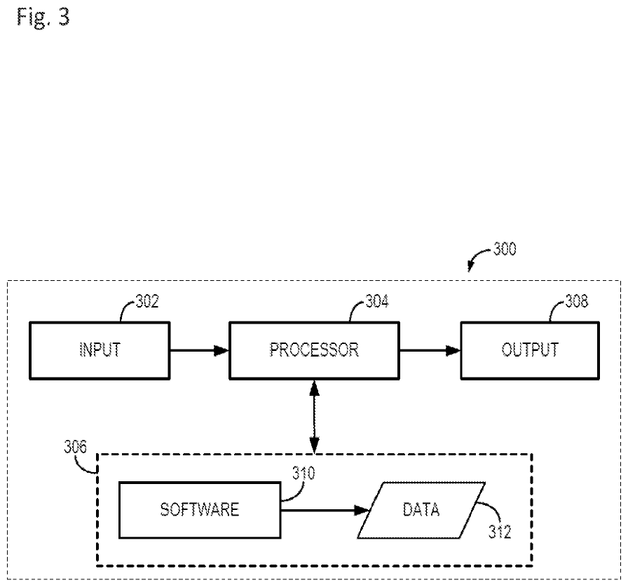

The methods described herein comprise the use of a system comprising ion source, current detector, ion injector, ion selector, one or more controllers, and a mass analyzer. Referring now to FIG. 3, a block diagram of an exemplary controller 300 that can be used to implement the methods described herein. The controller 300 generally includes an input 302, at least one hardware processor 304, a memory 306, and an output 308. Thus, the controller 300 is generally implemented with a hardware processor 304 and a memory 306. In some embodiments, the controller 300 can be implemented, in some examples, by a workstation, a notebook computer, a tablet device, a mobile device, a multimedia device, a network server, a mainframe, one or more microcontrollers, or any other general-purpose or application-specific computing device.

The controller 300 may operate autonomously or semi-autonomously, or may read executable software instructions from the memory 306 or a computer-readable medium (e.g., a hard drive, a CD-ROM, flash memory), or may receive instructions via the input 302 from a user, or any another source logically connected to a computer or device, such as another networked computer, server. The input 302 may take any shape or form, as desired, for operation of the controller 300, including the ability for selecting, entering, or otherwise specifying parameters consistent with operating the controller 300.

In general, the controller 300 is programmed or otherwise configured to implement the methods and algorithms in the present disclosure. For instance, the controller 300 can be programmed to determine a target m/z, generate a target mass report, control an ion selector, or any combination thereof. In some embodiments, the controller 300 is programmed to determine a target m/z by generating a mass spectrum, selecting mass spectrum signals above a relative intensity threshold, generate a parallelized m/z spectrum, or any combination thereof. In some aspects, the controller 300 may be programmed to access acquired data from a mass spectrometry unit, such as mass spectrometry data that includes mass spectrum peaks corresponding to ions. Alternatively, the mass spectrum may be provided to the controller 300 by acquiring the data using a mass spectrometry unit and communicating the acquired data to the controller 300, which may be part of the mass spectrometry unit.

The presently disclosed technology is not particularly limited by the choice of mass spectrometry unit so long as it is capable of generating mass spectrometry data. The mass spectrometry unit may be used to analyze any sample having one or more proteoforms therein and utilize a variety of different infusion, ionization, or detector methods or hardware. For example, the mass spectrometry unit may utilize detectors such as linear ion traps, image current detectors, time-of-flight detectors, and the like.

The input 302 may take any suitable shape or form, as desired, for operation of the controller 300, including the ability for selecting, entering, or otherwise specifying parameters consistent with performing tasks, processing data, or operating the computer system 300. In some aspects, the input 302 may be configured to receive data, such as data acquired with a mass spectrometry unit. Such data may be processed as described above to determine a target m/z, generate a target mass report, control an ion selector, or any combination thereof. In addition, the input 302 may also be configured to receive any other data or information considered useful for determine a target m/z, generate a target mass report, control an ion selector, or any combination thereof.

Among the processing tasks for operating the computer system 300, the one or more hardware processors 304 may also be configured to carry out a number of post-processing steps on data received by way of the input 302. For example, the processor 304 may be configured to determine a target m/z, generate a target mass report, control an ion selector, or any combination thereof using experimental mass spectrometry data.

The memory 306 may contain software 310 and data 312, such as data acquire with a mass spectrometry unit, and may be configured for storage and retrieval of processed information, instructions, and data to be processed by the one or more hardware processors 304. In some aspects, the software may contain instructions directed to processing the input mass spectrum or mass spectrometry data to be processed by the one or more hardware processors 304. In some aspects, the software 310 may contain instructions directed to processing the mass spectrometry data or mass spectrum in order to determine a target m/z, generate a target mass report, control an ion selector, or any combination thereof.

One aspect of the invention is a method for I²MS. I²MS may be suitably used to identifying analytes within samples. Samples may be obtained from natural sources, such as a biosample obtained from a subject, or be man-made. Analytes may include, but are not limited to, one or more proteoforms or complexes thereof, such as antibodies, metalloproteins, protein-protein complexes, protein-ligand complexes, singular protein chains, in a sample. As used herein, “proteoform” refers to all of the different molecular forms in which the protein product of a single gene can be found, including changes due to genetic variations, alternatively spliced RNA transcripts and posttranslational modifications, and the like.

From the detected ions, the mass of each of the ions may be determined with a mass analyzer. As used herein, “mass analyzer” may include a programmable processor or combination of processors, such as central processing units (CPUs), graphics processing units (GPUs), Field Programmable Gate Arrays (FPGAs), Application-Specific Integrated Circuits (ASICs) and the like. As such, the mass analyzer may be configured to execute instructions stored in a non-transitory computer readable-media. In this regard, the mass analyzer may be a computer, workstation, laptop or other general-purpose computing device. Additionally or alternatively, the controller may also include one or more dedicated processing units or modules that may be configured (e.g. hardwired, or pre-programmed) to carry out steps, in accordance with aspects of the present disclosure.

The presently disclosed automated I²MS (charge detection) platform has been successfully integrated into a full solution for processing a sample comprising one and a multiplicity of proteoforms to identify target m/z that can be used in tandem mass spectrometry. High throughput automation of I²MS analysis enables fast and robust acquisition of high-resolution mass spectra for intact proteins.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

### Example 1

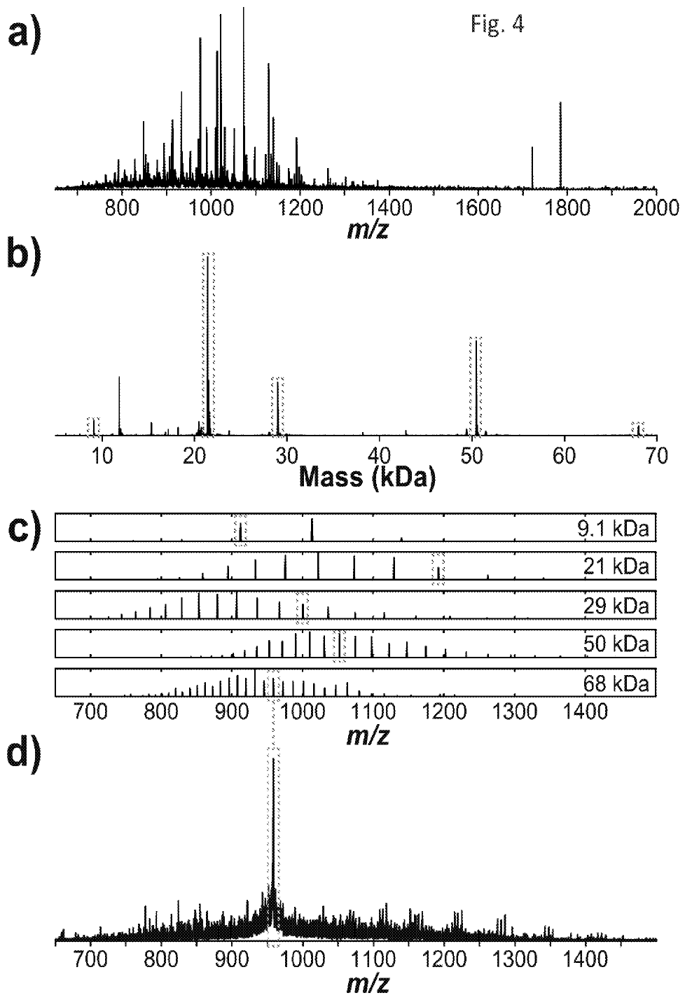

FIGS. 4-9 demonstrate that the methods and systems described herein may be used to direct data-dependent analysis on a protein mixture: Pierce Protein Standard Mix.

The unprocessed spectrum features several overlapping species in the m/z domain (FIG. 4a). After running a standard intact I²MS survey (FIG. 4b), the ion table for the mass spectrum was exported from Oso using SQLite. The system then recreates the finalized mass spectrum and flags species for further characterization (boxes). These targeted masses, comprising of ion populations of an m/z and assigned charge, are used to reconstruct a parallelized m/z spectrum in silico against all targeted species (FIG. 4c). The system compares and scores the various peaks of each species against those of all other species to determine the ideal m/z target for each species (boxes). Each target can then be fragmented in I²MS or traditional ensemble modes (FIG. 4d), with the choice of fragmentation mode being completely independent and flexible.

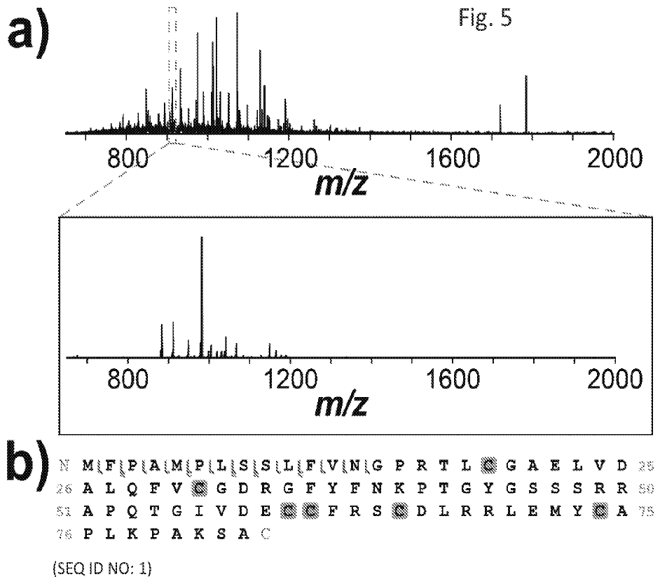

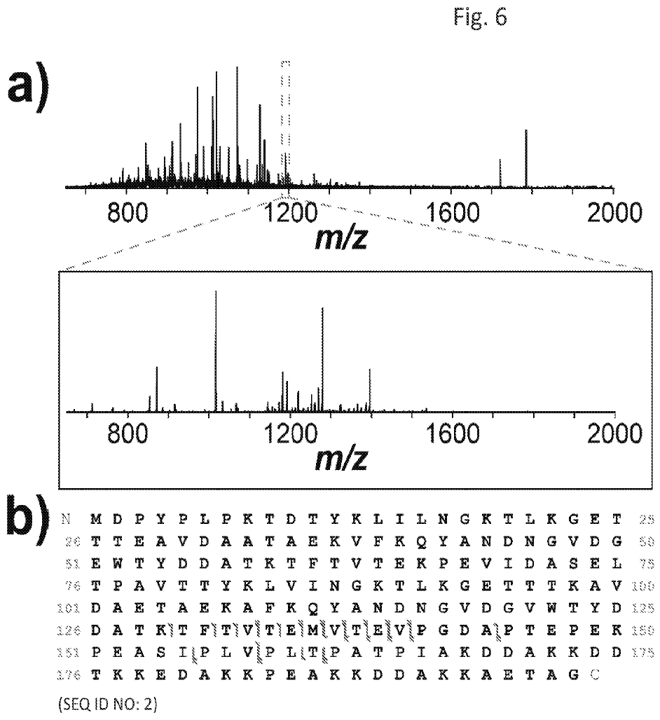

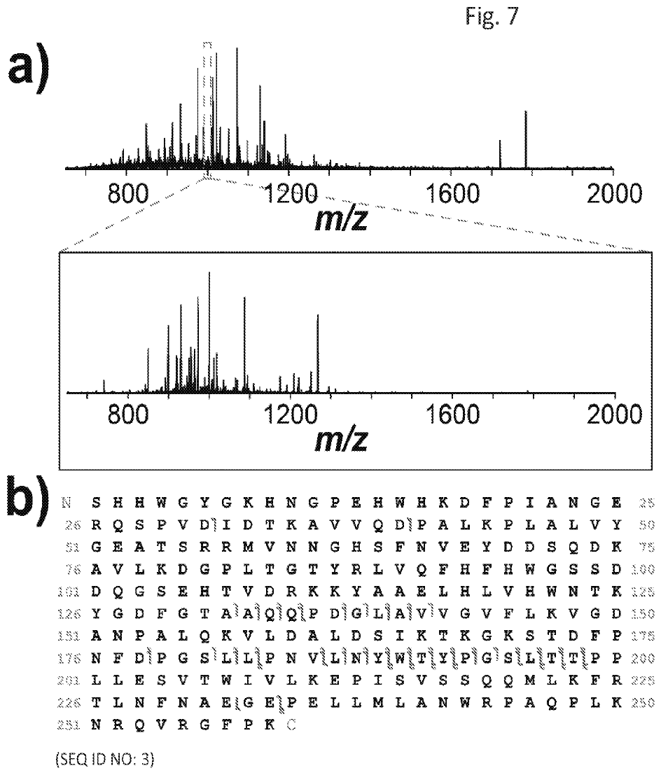

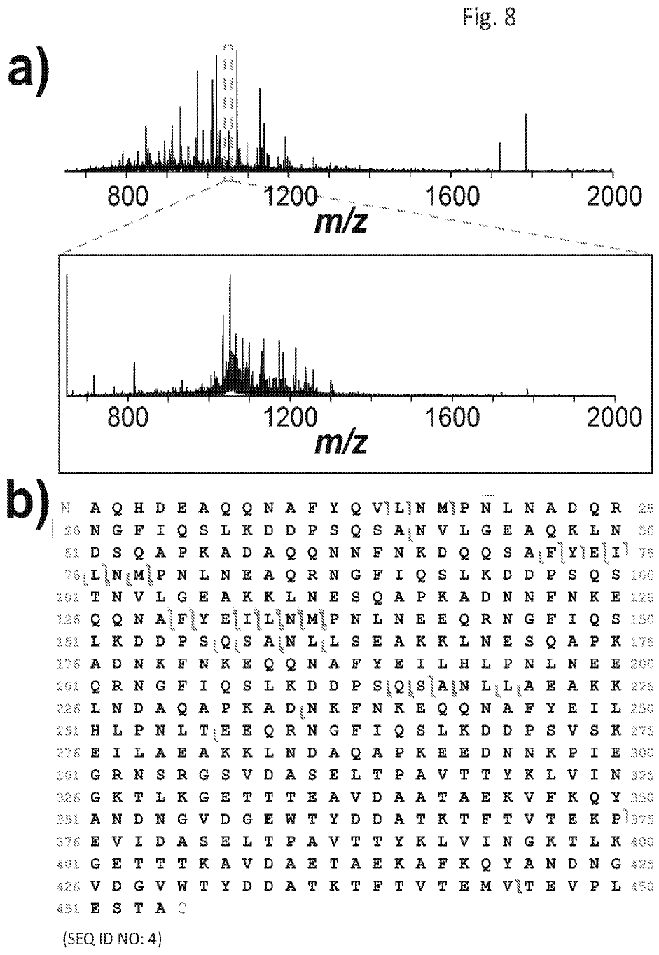

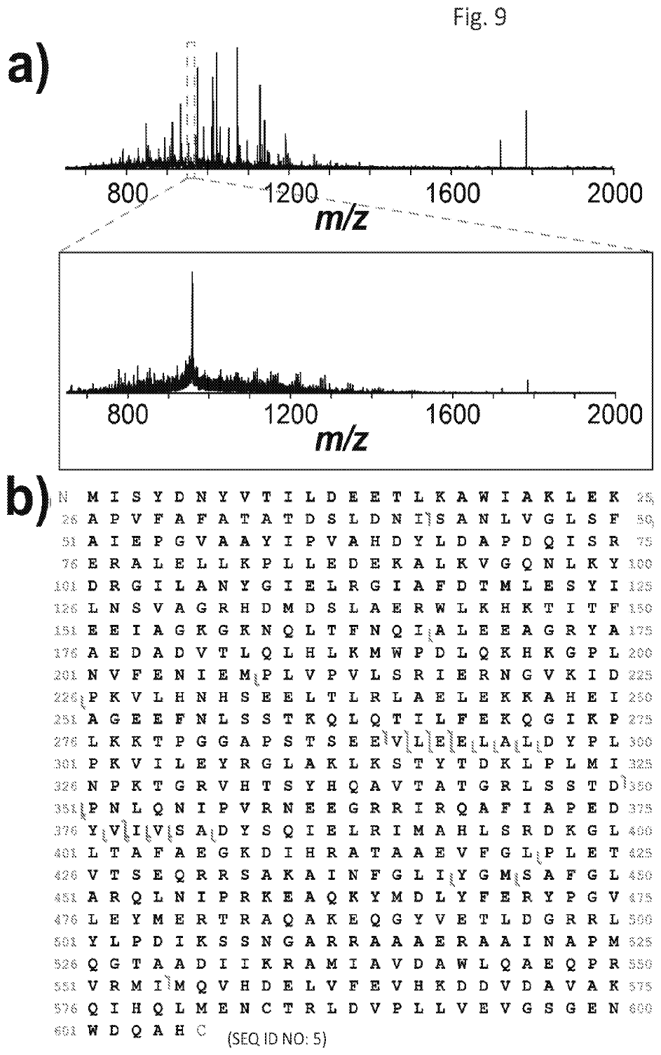

FIGS. 5-9 demonstrate the specificity for the methods and systems described herein in selecting for proteoforms within the Pierce Protein Standard Mix: human IGF-1 LR3 (FIG. 5), Streptococcus protein A/G (FIG. 6), bovine carbonic anhydrase II (FIG. 7), S. dysgalactiae protein G (FIG. 8), and E. coli exo klenow (FIG. 9). All targets (FIGS. 5-9a) are identified in the original mixture (top) and selected for fragmentation (bottom) in the target m/z domain as directed by the system, and the resultant fragments are annotated against (FIG. 5b) human IGF-1 LR3, (FIG. 6b) Streptococcus protein A/G, (FIG. 7b) bovine carbonic anhydrase II, (FIG. 8b) S. dysgalactiae protein G, and (FIG. 9b) E. coli exo klenow. Flags denote annotated fragments taken from the averaged raw data or I²MS mode. Every case in this example demonstrates that directed targeting largely eliminates off-target fragments for Pierce Protein Standard Mix out to ˜70 kDa.

For this experiment, the Pierce Protein Standard Mix was diluted using denaturing solution (˜30% acetonitrile and ˜1% acetic acid in water) such that each protein component was present in amounts ranging from high nanomolar to low micromolar in concentration. The mixture was infused via syringe pump into a heated electrospray source, which sprayed the mixture into a Q Exactive Plus for I²MS analysis.

### Example 2

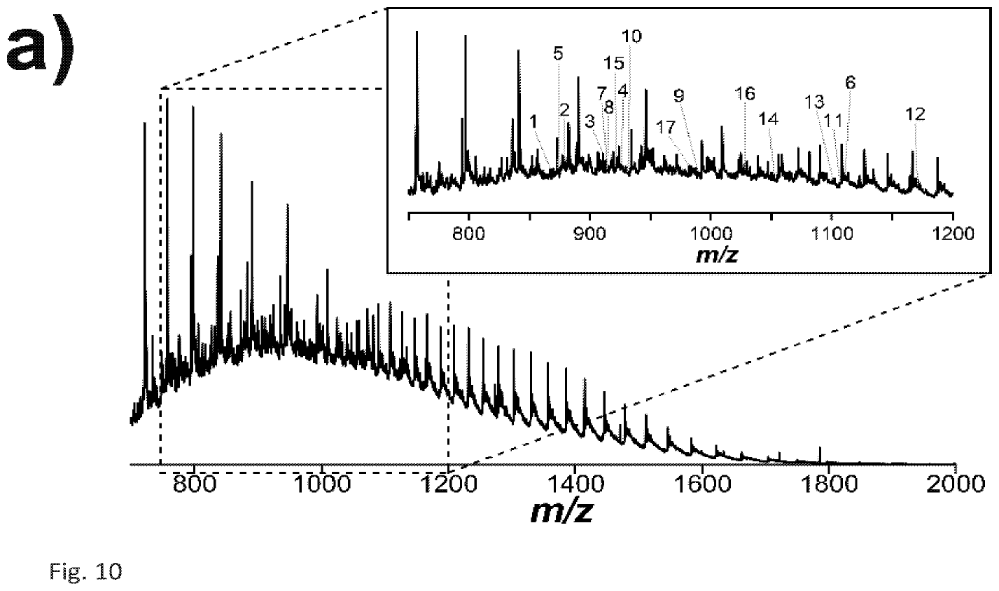

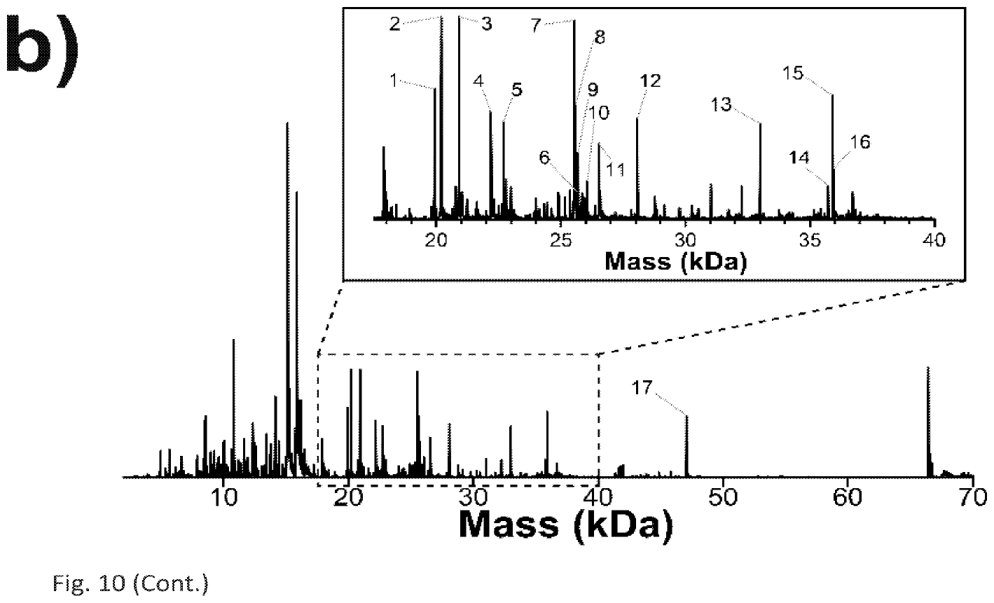

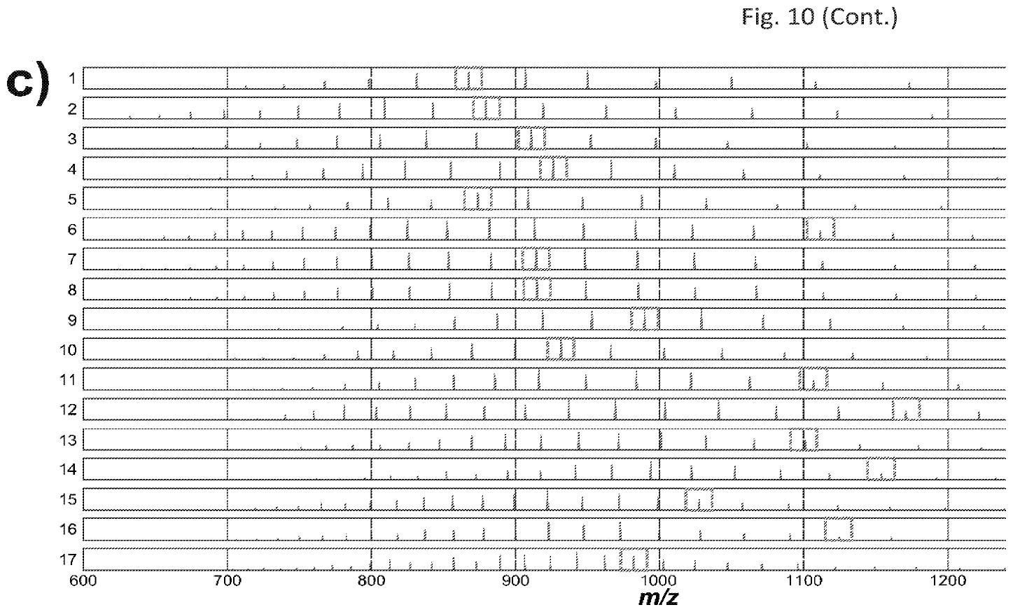

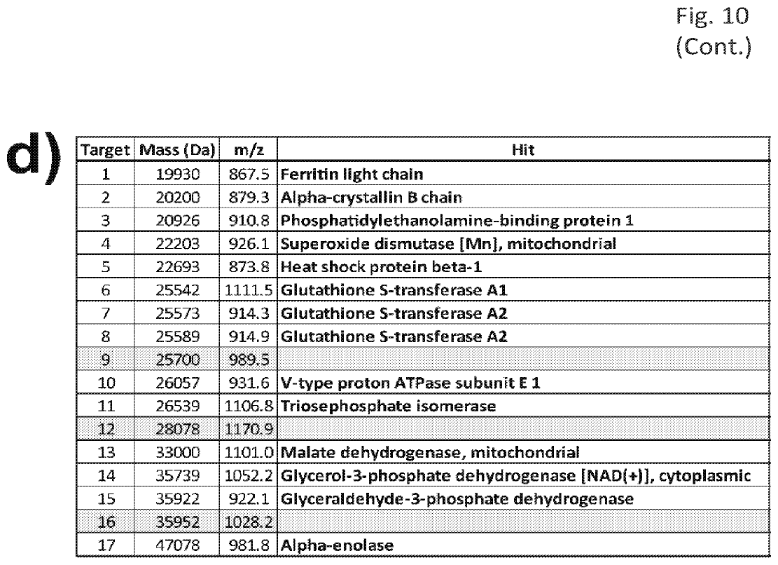

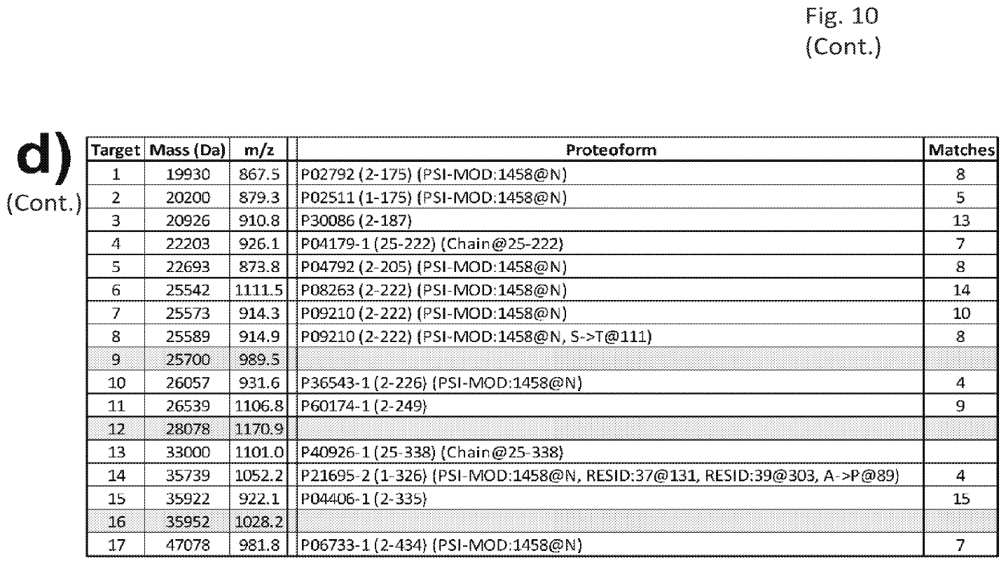

FIG. 10 demonstrates that methods and systems described herein can be used to direct data-dependent analysis on a complex, non-standard mixture of proteins. Specifically, nanospray-desorption electrospray ionization (nano-DESI) was used to sample proteins across a section of healthy human kidney tissue, resulting in a (a) large and broad distribution in m/z space. (b) Nano-DESI coupled to I²MS yielded an intact mass spectrum, which was used to identify 17 targets for further characterization. (c) The system created a parallelized m/z spectrum of the 17 targets in silico and evaluated each of the 17 distributions to determine the ideal place to isolate in m/z space (boxes). (d) Sampling these 17 targets directly off of tissue using nano-DESI coupled to I²MS yielded a table of identifications, where 14 out of the 17 targets were confidently annotated.

Fresh frozen human kidney tissue section was thawed, fixed and delipidated via a series of ethanol and chloroform treatments before analysis. Nano-DESI imaging probe was assembled using a pair of fused silica capillaries (OD 150 μm, ID 40 μm). In particular, a solvent optimized for denatured protein extraction (60%/39.4% acetonitrile/water and 0.6% acetic acid) was propelled through the probe. Protein molecules from tissue were extracted using a liquid bridge formed at the junction of the two capillaries, transferred to MS, and detected as multiply charged ions. To perform data-dependent analysis on tissue, a survey line scan on tissue was first performed to obtain m/z, charge state distribution of the proteins along with their relative abundances in the line region. The survey line scan was performed on a 14×0.15 mm area at a lateral scan rate of 4 μm/s. In the next step, MS/MS data acquisition for 17 targets on an adjacent 14×0.15 mm region of the same tissue was performed under identical sampling conditions as the survey line scan. MS/MS data acquisition method containing 17 MS/MS events was generated in silico according to the survey. In each MS/MS event, an 0.8 m/z isolation window corresponding to a favorable charge state of a target was selected, during which collision-induced dissociation at 12 eV/charge was applied to generate fragment ions. The MS/MS data was processed using I²MS workflow and subjected to database searching against the Swiss-Prot human protein database for target identification.

### Example 3

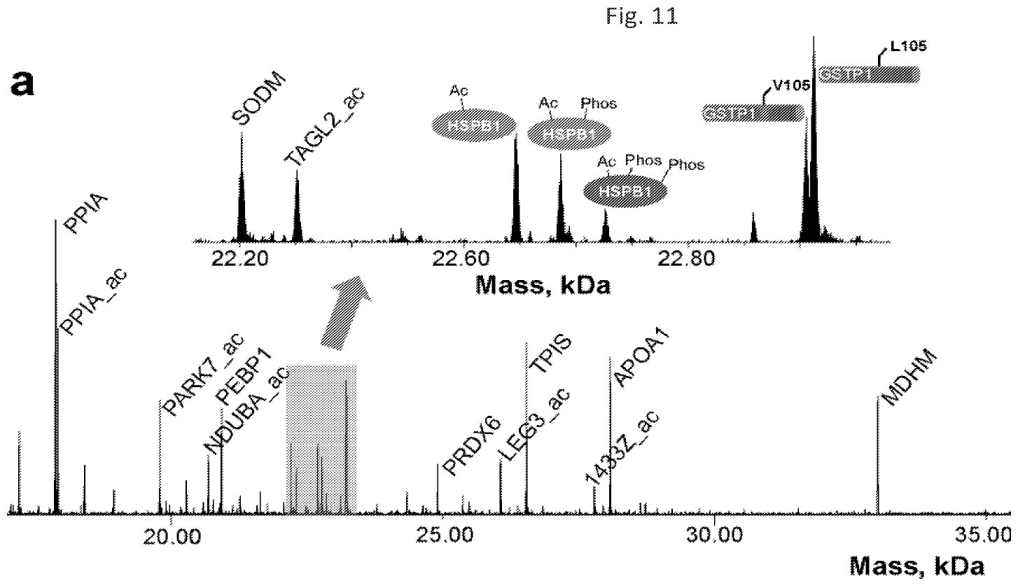

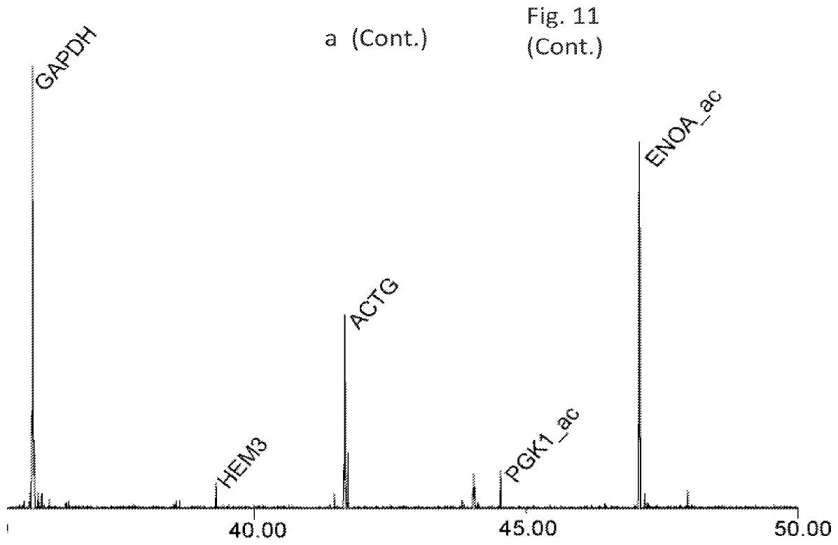

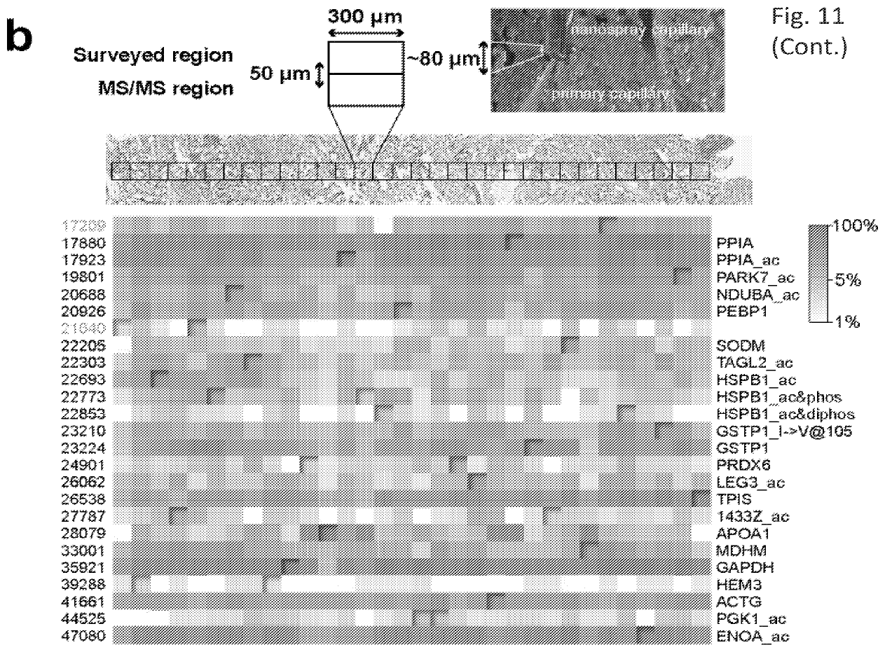

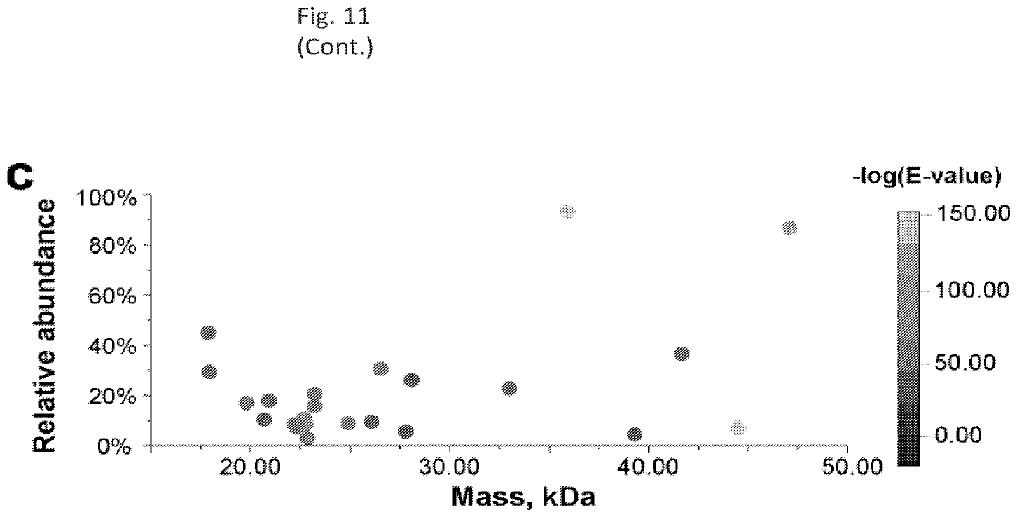

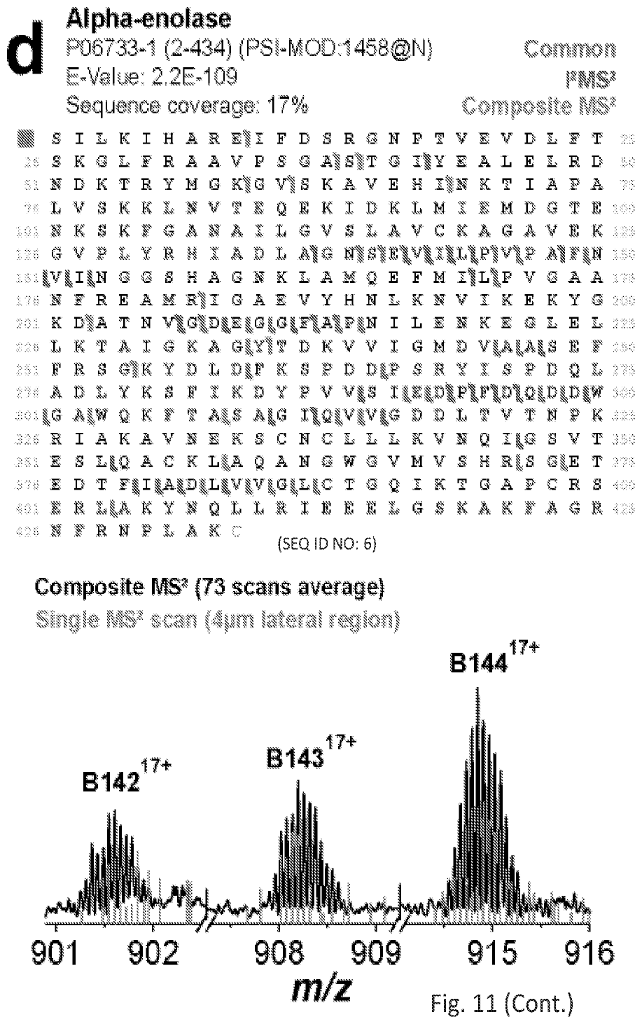

FIG. 11 demonstrates where the proteoforms being targeted are most abundant on a human ovary tumor tissue surface. In this iteration we consider where the intact proteoforms were most abundant or if they were only present for a small section of the tissue before picking when to multiplex their fragmentation.

In this experiment, a nano-DESI line scan was performed on a 14×0.15 mm region of a human ovarian epithelial tumor tissue. Nano-DESI sampling conditions and tissue pretreatment are similar as described in Example 2. A ˜53.6 kDa proteoform was observed from the survey line scan, which was only found at relatively high abundance at spatial bin #19 (arrow FIG. 11a). To identify this proteoform, we performed MS/MS experiment to target this proteoform at spatial bin #19.To improve the sensitivity of precursor isolation, an optimal isolation window was found in silico for charge state 56+ of this proteoform (957.5±0.4 Da, red box), and 62 MS/MS scans were collected on a location offset from bin #19 by 100 μm. Based on database searching results, we identified this proteoform as N-terminal acetylated vimentin (UniProt accession: P08670) with 6% sequence coverage.

1. A method for determining a target m/z, the method comprising:
producing, with an ion source, ions of a sample, each of the ions having a mass-to-charge (m/z) ratio;
generating, with a detector, detector signals corresponding to the m/z ratios of ions in the sample; and
determining, with a controller, the target m/z, wherein the target m/z is selected for an intact-mass corresponding to an analyte of interest.

2. The method of claim 1, wherein the m/z target increases the yield of the intact-mass corresponding to the analyte of interest and reduces the yield of one or more additional detectable masses.

3. The method of claim 2, wherein the one or more additional detectable masses comprise a mass of a fragment of the analyte of interest, a mass of a fragment of a co-isolate, an intact-mass of a co-isolate, or any combination thereof.

4. The method of claim 1, wherein the target m/z is determined by:
generating a mass spectrum from detector signals corresponding to the m/z ratios of ions in the sample;
selecting, from the mass spectrum, mass spectrum signals above a relative intensity threshold to determine masses of interest;
generating, from each of the masses of interest, a parallelized m/z spectrum, wherein the parallelized m/z spectrum comprises reconstructed m/z spectra for each of the masses of interest; and
determining from the reconstructed m/z spectra for each of the masses of interest the target m/z.

5. A method for determining a mass spectrum, the method comprising:
producing, with an ion source, ions of a sample, each of the ions having a mass-to-charge (m/z) ratio;
generating, with a detector, detector signals at a target m/z, wherein the target m/z is selected for an intact-mass corresponding to an analyte of interest; and
determining, with a mass analyzer, a mass spectrum for the target m/z.

6. The method of claim 5, wherein the m/z target increases the yield of the intact-mass corresponding to the analyte of interest and reduces the yield of one or more additional detectable masses.

7. The method of claim 6, wherein the one or more additional detectable masses comprise a mass of a fragment of the analyte of interest, a mass of a fragment of a co-isolate of interest, an intact-mass of a co-isolate, or any combination thereof.

8. The method of claim 5, wherein the target m/z is determined by:
generating a mass spectrum from detector signals corresponding to the m/z ratios of ions in the sample;
selecting, from the mass spectrum, mass spectrum signals above a relative intensity threshold to determine masses of interest;
generating, from each of the masses of interest, a parallelized m/z spectrum, wherein the parallelized m/z spectrum comprises reconstructed m/z spectra for each of the masses of interest; and
determining from the reconstructed m/z spectra for each of the masses of interest the target m/z.

9. A method for generating a target mass report, the method comprising:
producing, with an ion source, ions of a sample, each of the ions having a mass-to-charge (m/z) ratio;
generating, with a detector, detector signals corresponding to the m/z ratios of ions in the sample; and
generating, with a controller, a target mass report, wherein the target mass report comprises a target mass for an analyte of interest, one or more target m/z for the target mass of the analyte of interest, a charge state for each of the one of more target m/z, and, if present, additional detectable masses for each target m/z.

10. The method of claim 9, wherein the target mass report is generated by:
generating, with a mass analyzer, a mass spectrum from detector signals corresponding to the m/z ratios of ions in the sample;
selecting, from the mass spectrum, mass spectrum signals above a relative intensity threshold to determine masses of interest;
generating, from each of the masses of interest, a parallelized m/z spectrum, wherein the parallelized m/z spectrum comprises reconstructed m/z spectra for each of the masses of interest; and
comparing the reconstructed m/z spectra for each of the masses of interest.

11. A system for determining a target m/z configured to perform the method according to the method of claim 1, the system comprising:
(a) an inlet portion configured to receive a sample;
(b) an ion source configured to ionize the sample to ions, each of the ions having a mass-to-charge (m/z) ratio;
(c) the detector configured to generate detector signals corresponding to the m/z ratio of detected ions; and
(e) a controller configured to receive the detector signals and programmed to determine the target m/z, wherein the target m/z is selected for an intact-mass corresponding to an analyte of interest.

12. The system of claim 11, wherein the determineCurrd target m/z increases the yield of the intact-mass corresponding to the analyte of interest and reduces the yield of one or more additional detectable masses.

13. The system of claim 12, wherein the one or more additional detectable masses comprise a mass of a fragment of the analyte of interest, a mass of a fragment of a co-isolate of interest, an intact-mass of a co-isolate, or any combination thereof.

14. The system of claim 11, wherein the controller is configured to determine the target m/z by:
generating a mass spectrum from detector signals corresponding to the m/z ratios of ions in the sample;
selecting, from the mass spectrum, mass spectrum signals above a relative intensity threshold to determine masses of interest;
generating, from each of the masses of interest, a parallelized m/z spectrum, wherein the parallelized m/z spectrum comprises reconstructed m/z spectra for each of the masses of interest; and
determining from the reconstructed m/z spectra for each of the masses of interest the target m/z.

15. A system for determining a mass spectrum configured to perform the method according to claim 5, the system comprising:
(a) an inlet portion configured to receive a sample;
(b) an ion source configured to ionize the sample to ions, each of the ions having a mass-to-charge (m/z) ratio;
(c) an ion selector configured to select ions having a target m/z;
(d) the detector configured to generate detector signals corresponding to the selected ions; and
(e) a controller configured to receive the detector signals and programmed to determine a mass spectrum,
wherein the target m/z is selected for an intact-mass corresponding to an analyte of interest.

16. The system of claim 15, wherein the determined target m/z increases the yield of the intact-mass corresponding to the analyte of interest and reduces the yield of one or more additional detectable masses.

17. The system of claim 16, wherein the one or more additional detectable masses comprise a mass of a fragment of the analyte of interest, a mass of a fragment of a co-isolate of interest, an intact-mass of a co-isolate, or any combination thereof.

18. The system of claim 15, wherein system further comprises a controller configured to determine the target m/z.

19. The system of claim 15, wherein the target m/z is determined by:
generating a mass spectrum from detector signals corresponding to the m/z ratios of ions in the sample;
selecting, from the mass spectrum, mass spectrum signals above a relative intensity threshold to determine masses of interest;
generating, from each of the masses of interest, a parallelized m/z spectrum, wherein the parallelized m/z spectrum comprises reconstructed m/z spectra for each of the masses of interest; and
determining from the reconstructed m/z spectra for each of the masses of interest the target m/z.

20. A system for generating a target mass report configured to perform the method according to claim 9, the system comprising:
(a) an inlet portion configured to receive a sample;
(b) an ion source configured to ionize the sample to ions, each of the ions having a mass-to-charge (m/z) ratio;
(c) the detector configured to generate detector signals corresponding to the m/z ratio of detected ions; and
(e) a controller configured to receive the detector signals and programmed to generate a target mass report, wherein the target mass report comprises a target mass for an analyte of interest, one or more target m/z for the target mass of the analyte of interest, a charge state for each of the one of more target m/z, and, if present, additional detectable masses for each target m/z.

21. The system of claim 20, wherein the target mass report is generated by:
generating, with a mass analyzer, a mass spectrum from detector signals corresponding to the m/z ratios of ions in the sample;
selecting, from the mass spectrum, mass spectrum signals above a relative intensity threshold to determine masses of interest;
generating, from each of the masses of interest, a parallelized m/z spectrum, wherein the parallelized m/z spectrum comprises reconstructed m/z spectra for each of the masses of interest; and
comparing the reconstructed m/z spectra for each of the masses of interest.


SEQUENCE LISTING (6 sequences)

SEQ ID NO: 1 - protein, 83 aa, Homo sapiens
MFPAMPLSSLFVNGPRTLCGAELVDALQFVCGDRGFYFNKPTGYGSSSRRAPQTGIVDECCFRSCDLRRLEMYCAPLKPAKSA

SEQ ID NO: 2 - protein, 198 aa, Streptococcus sp.
MDPYPLPKTDTYKLILNGKTLKGETTTEAVDAATAEKVFKQYANDNGVDGEWTYDDATKTFTVTEKPEVIDASELTPAVTTYKLVINGKTLKGETTTKAVDAETAEKAFKQYANDNGVDGVWTYDDATKTFTVTEMVTEVPGDAPTEPEKPEASIPLVPLTPATPIAKDDAKKDDTKKEDAKKPEAKKDDAKKAETAG

SEQ ID NO: 3 - protein, 259 aa, Bos sp.
SHHWGYGKHNGPEHWHKDFPIANGERQSPVDIDTKAVVQDPALKPLALVYGEATSRRMVNNGHSFNVEYDDSQDKAVLKDGPLTGTYRLVQFHFHWGSSDDQGSEHTVDRKKYAAELHLVHWNTKYGDFGTAAQQPDGLAVVGVFLKVGDANPALQKVLDALDSIKTKGKSTDFPNFDPGSLLPNVLNYWTYPGSLTTPPLLESVTWIVLKEPISVSSQQMLKFRTLNFNAEGEPELLMLANWRPAQPLKNRQVRGFPK

SEQ ID NO: 4 - protein, 454 aa, Streptococcus dysgalactiae
AQHDEAQQNAFYQVLNMPNLNADQRNGFIQSLKDDPSQSANVLGEAQKLNDSQAPKADAQQNNFNKDQQSAFYEILNMPNLNEAQRNGFIQSLKDDPSQSTNVLGEAKKLNESQAPKADNNFNKEQQNAFYEILNMPNLNEEQRNGFIQSLKDDPSQSANLLSEAKKLNESQAPKADNKFNKEQQNAFYEILHLPNLNEEQRNGFIQSLKDDPSQSANLLAEAKKLNDAQAPKADNKFNKEQQNAFYEILHLPNLTEEQRNGFIQSLKDDPSVSKEILAEAKKLNDAQAPKEEDNNKPIEGRNSRGSVDASELTPAVTTYKLVINGKTLKGETTTEAVDAATAEKVFKQYANDNGVDGEWTYDDATKTFTVTEKPEVIDASELTPAVTTYKLVINGKTLKGETTTKAVDAETAEKAFKQYANDNGVDGVWTYDDATKTFTVTEMVTEVPLESTA

SEQ ID NO: 5 - protein, 605 aa, Escherichia coli
MISYDNYVTILDEETLKAWIAKLEKAPVFAFATATDSLDNISANLVGLSFAIEPGVAAYIPVAHDYLDAPDQISRERALELLKPLLEDEKALKVGQNLKYDRGILANYGIELRGIAFDTMLESYILNSVAGRHDMDSLAERWLKHKTITFEEIAGKGKNQLTFNQIALEEAGRYAAEDADVTLQLHLKMWPDLQKHKGPLNVFENIEMPLVPVLSRIERNGVKIDPKVLHNHSEELTLRLAELEKKAHEIAGEEFNLSSTKQLQTILFEKQGIKPLKKTPGGAPSTSEEVLEELALDYPLPKVILEYRGLAKLKSTYTDKLPLMINPKTGRVHTSYHQAVTATGRLSSTDPNLQNIPVRNEEGRRIRQAFIAPEDYVIVSADYSQIELRIMAHLSRDKGLLTAFAEGKDIHRATAAEVFGLPLETVTSEQRRSAKAINFGLIYGMSAFGLARQLNIPRKEAQKYMDLYFERYPGVLEYMERTRAQAKEQGYVETLDGRRLYLPDIKSSNGARRAAAERAAINAPMQGTAADIIKRAMIAVDAWLQAEQPRVRMIMQVHDELVFEVHKDDVDAVAKQIHQLMENCTRLDVPLLVEVGSGENWDQAH

SEQ ID NO: 6 - protein, 433 aa, unidentified
SILKIHAREIFDSRGNPTVEVDLFTSKGLFRAAVPSGASTGIYEATELRDNDKTRYMGKGVSKAVEHINKTIAPALVSKKLNVTEQEKIDKLMIEMDGTENKSKFGANAILGVSLAVCKAGAVEKGVPLYRHIADLAGNSEVILPVPAFNVINGGSHAGNKLAMQEFMILPVGAANFREAMRIGAEVYHNLKNVIKEKYGKDATNVGDEGGFAPNILENKEGLELLKTAIGKAGYTDKVVIGMDVAASEFFRSGKYDLDFKSPDDPSRYISPDQLADLYKSFIKDYPVVSIEDPFDQDDWGAWQKFTASAGIQVVGDDLTVTNPKRIAKAVNEKSCNCLLLKVNQIGSVTESLQACKLAQANGWGVMVSHRSGETEDTFIADLVVGLCTGQIKTGAPCRSERLAKYNQLLRIEEELGSKAKFAGRNFRNPLAK